(19) United States
(12) Patent Application Publication
(10) Pub. No.: US 2006/0116104 A1
(43) Pub. Date: Jun. 1, 2006

(54) Method for network search in a wireless communications system

(75) Inventor: Xiaosi Yang, Shanghai (CN)

Correspondence Address: PERKINS COIE LLP;PATENT-SEA, P.O. BOX 1247, SEATTLE, WA, 98111-1247, US

(73) Assignee: Spreadtrum Communications Corporation, Sunnyvale, CA (US)

(21) Appl. No.: 11/236,462

(22) Filed: Sep. 27, 2005

(30) Foreign Application Priority Data
Dec. 1, 2004 (CN) 200410084800.2

(51) Int. Cl. H04Q 7/20

(52) U.S. Cl. 455/403

(57) ABSTRACT

A method is provided for controlling cell search in a wireless communication device when there is no service cell is available. When the duration specified in a timer elapses after no service cell occurs, the wireless device starts the cell search operation. This operation repeats itself at certain intervals until the device successfully camps on a service cell; meanwhile, the value recorded in a timer increases itself by a certain number after each iteration.

### CROSS-REFERENCE TO RELATED APPLICATION

This application claims priority to Chinese Patent Application No. 200410084800.2 filed Dec. 1, 2004.

### TECHNICAL FIELD OF THE INVENTION

The present invention relates to a public land mobile network (PLMN) selection method for a wireless communication device, and in particular, to a PLMN selection method when in a no service state.

### DESCRIPTION OF THE RELATED ART

There are a number of situations or locations where a mobile subscriber (MS) may not be able to obtain normal service from a PLMN. These may include being underground, in an elevator, in a subway, or fast moving (auto or train) scenarios. Under these conditions, a phone call cannot be placed; moreover, incoming calls may be missed. These occurrences can have negative emotional and financial effects on a phone owner, as well as on those who want to get in touch with the phone user. Thus, a need exists for a method implemented in the mobile subscriber terminal to accelerate getting into contact with a network.

A conventional method addressing this problem is that the MS device indicates “no service” to the user. After a predetermined time elapses, the MS device starts a network searching procedure, which actually comprises of several tasks. For example, there is a cell selection process, a location updating process, etc. These tasks are executed in a predetermined order. The network searching procedure will repeat until the MS device successfully registers with the network.

However, a large amount of battery life is consumed while performing this selection process. Power consumption is a critical factor in evaluating a wireless devices' performance, and a wireless communication device designer generally makes substantial effort in designing a power efficient device. On the other hand, it is desirable to have quick network service recovery using a network searching procedure. A dilemma therefore arises where if a long duration between the successive network searching procedures is set; the efficiency of network searching is compromised, whereas a short interval may bring about undesired power consumption.

It is therefore advantageous to develop a control method for a wireless device to perform a network searching procedure which is power efficient, while minimizing the time taken to find an available network.

### SUMMARY OF THE INVENTION

The present invention provides a method capable of readily and effectively achieving network service for the wireless device. To minimize the time taken to achieve network service recovery while maintaining battery life, a discontinuous (in time) search scheme is used. The wireless device implements the proposed method using a timer. When the mobile subscriber device finds that service is unavailable, the MS initiates a network search operation; when the timer reaches expiration, and the network search procedure does not lead to a successful registration with the network, another procedure is executed. The timer is initiated with respect to certain rules.

The present method achieves an effective saving in both the battery life and the time taken of regaining network service. To accomplish this, this method on one hand dynamically reloads the timer so that the expiry time to trigger the next network searching procedure will be lengthened, therefore not to cause too much power consumption. On the other hand, the method achieves a quick network service recovery.

### BRIEF DESCRIPTION OF THE DRAWINGS

The foregoing aspects and many of the attendant advantages of the invention will become more readily appreciated as the same become better understood by reference to the following detailed description, when taken in conjunction with the accompanying drawings.

FIG. 1 is the flow chart illustrating a method for network search according to the present invention.

### DESCRIPTION OF THE PREFERRED EMBODIMENT

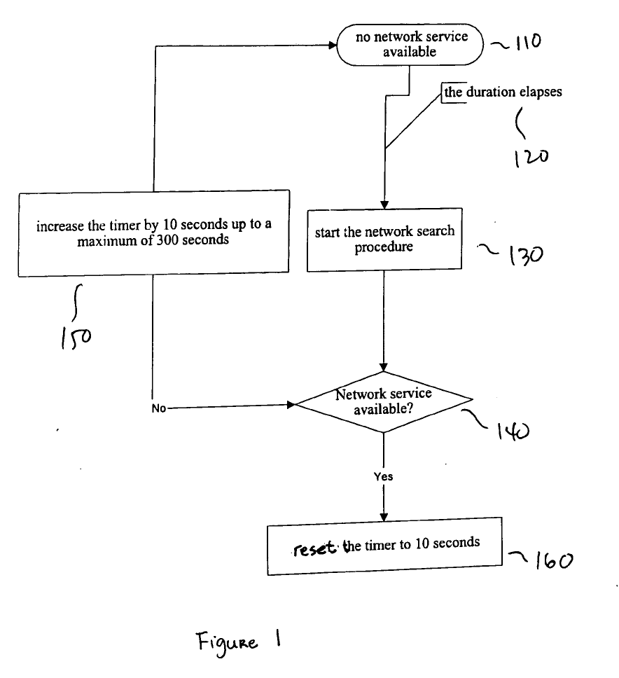

With reference to FIG. 1, in one embodiment of the present invention, a network search method described herein may be implemented in any wireless communication device, such as a cellular phone.

First, the cellular phone determines at step 110 that no service is available. Next, a timer maintained by the cellular phone is started after the no service indication is determined. At step 120, the timer will elapse after a period T if the no service state continues. Then, at step 130, the cellular phone starts a network search procedure.

If a successful search is made (at step 140), the phone indicates the selected PLMN and the value established in the timer shall be reset to 10 seconds at step 160.

If the phone determines at step 140 that there is still no available network service, the timer is increased by 10 seconds at step 150. The amount of the increase in the timer is known as the predetermined increment and may vary from the example of 10 seconds provided herein. The periodic incrementing of the timer continues until it reaches a maximum value, for example 300 seconds. It can appreciated that the maximum value of the timer may vary from the example of the 300 seconds provided herein.

In other words, so long as the phone fails to find any network, the network search procedure is to be repeated. Note, however, the timeout value to trigger the (N−1)th network search procedure is 10 seconds shorter than that of to trigger Nth procedure.

In case that the phone does not obtain network service while the timer reaches the maximum of 300 seconds, the value of 300 seconds shall remain in the timer until the network search procedure is successfully executed.

The method described herein for network search of a wireless device provide the advantage of completing network search without compromising the power efficiency. Meanwhile, it is to be appreciated that the proposed method is at no expense of the time taken to fulfill the network service recovery.

While particular embodiments of the present invention have been described herein in detail, it is to be understood that various alterations, modifications and substitutions can be made therein without departing in any way from the spirit and scope of the present invention, as defined in the claims which follow. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for network search in a wireless device when no network service is available, the method comprising:
(a) starting a network search after a timer in said wireless device elapses;
(b) if service is still unavailable after performing said network search, incrementing said timer by a predetermined increment;
(c) starting another network search after said timer has been incremented;
(d) repeat steps (a)-(c) until network service is obtained.

2. The method of claim 1 wherein said timer has a maximum value wherein said timer is no longer incremented.

3. The method of claim 1 wherein said timer is reset to an initial value when the network service is obtained.

4. The method of claim 3 wherein said initial value is 10 seconds.

5. The method of claim 1 wherein said predetermined increment is 10 seconds.

6. The method of claim 2 wherein said maximum value is 300 seconds.
